(19) United States
(12) Patent Application Publication
(10) Pub. No.: US 2010/0020352 A1
(43) Pub. Date: Jan. 28, 2010

(54) IMAGE FORMING SYSTEM AND IMAGE FORMING APPARATUS

(75) Inventor: Toshimitsu Morimoto, Osaka (JP)

Correspondence Address: K&L Gates LLP, P.O. Box 1135, CHICAGO, IL, 60690, US

(73) Assignee: KYOCERA MITA CORPORATION, Osaka (JP)

(21) Appl. No.: 12/419,602

(22) Filed: Apr. 7, 2009

(30) Foreign Application Priority Data
Jul. 22, 2008 (JP) 2008-188230

(51) Int. Cl. G06F 3/12

(52) U.S. Cl. 358/1.15

(57) ABSTRACT

An image forming apparatus, wherein a SOAP processing section determines, when a communication processing section receives a document data request message from a client apparatus, whether a request message for causing an image reading apparatus to read a document image and to generate document data and requesting transmission of the document data or a request message for requesting transmission of the document data within a document box is represented by the document data request message, generates a response message containing the document data corresponding to the document data request message, and causes the communication processing section to transmit the response message to the client apparatus.

### INCORPORATION BY REFERENCE

This application is based upon and claims the benefit of priority from the corresponding Japanese Patent Application No. 2008-188230, filed Jul. 22, 2008, the entire contents of which is incorporated herein by reference.

### BACKGROUND

1. Field of the Invention

The present invention relates to an image forming system and an image forming apparatus.

2. Description of the Related Art

In general, there are two methods that allow a client apparatus (for example, a personal computer) to acquire image data generated by a scanner. In one of the methods, the client apparatus controls the scanner to read an image and immediately acquires the generated image data. In the other method, the client apparatus controls the scanner to output image data and store the image data on a hard disk drive, and acquires the image data from the hard disk drive thereafter.

As illustrated in FIG. 3, there is a system capable of performing both a method that allows the client apparatus to immediately acquire document data generated by an image reading apparatus of a multifunction peripheral and a method that allows the client apparatus to store document data generated by the image reading apparatus in a document box and acquire the document data from the document box.

However, the driver program for accessing the image reading apparatus and the driver program for accessing the document box are separately developed. Therefore, the communication protocol used for accessing the image reading apparatus and the communication protocol used for accessing the document box are often different from each other. This imposes a significant burden on the development of a driver program used for the client apparatus to acquire the document data generated by the image reading apparatus.

### SUMMARY

The present invention provides an image forming system, an image forming apparatus and method which can reduce the burden imposed on the development of a driver used for a client apparatus to acquire document data generated by an image reading apparatus.

An image forming system according to an embodiment of the present invention includes: an image forming apparatus connected to a computer network; and a client apparatus connected to the computer network.

The image forming apparatus comprises: an image reading apparatus that reads a document image and generates document data; a data storage device that stores the document data; a first communication processing section that receives a document data request message and transmits a response message via one predetermined communication protocol; and a first message processing section that determines, when the first communication processing section receives the document data request message from the client apparatus, whether a request message for causing the image reading apparatus to read the document image and to generate the document data and requesting transmission of the document data or a request message for requesting transmission of the document data within the data storage device is represented by the document data request message, generates the response message containing the document data corresponding to the document data request message, and causes the first communication processing section to transmit the response message to the client apparatus.

The client apparatus comprises: a second communication processing section that transmits the document data request message and receives the response message via the predetermined communication protocol; and a second message processing section that causes the second communication processing section to transmit the document data request message to the image forming apparatus, and extracts, when the second communication processing section receives the response message from the image forming apparatus, the document data from the response message.

Additional features and advantages are described herein, and will be apparent from the following Detailed Description and the figures.

### BRIEF DESCRIPTION OF THE FIGURES

In the accompanying drawings:

FIG. 1 is a schematic block diagram illustrating a structure of an image forming system according to an embodiment of the present invention;

FIG. 2 is a schematic diagram describing the operation of the components of the image forming system illustrated in FIG. 1; and

FIG. 3 is a schematic diagram describing a plurality of methods that allow a client apparatus to acquire document data generated by an image reading apparatus.

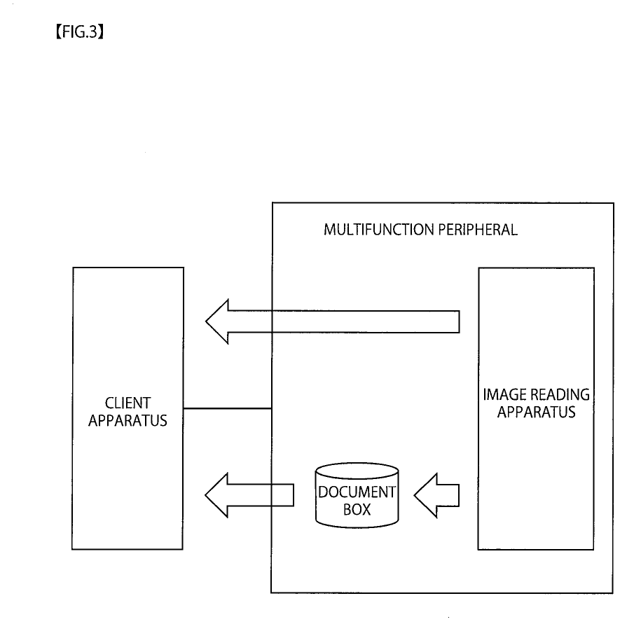

### DETAILED DESCRIPTION

Hereinafter, a description of an embodiment of the present invention with reference to the drawings will be provided.

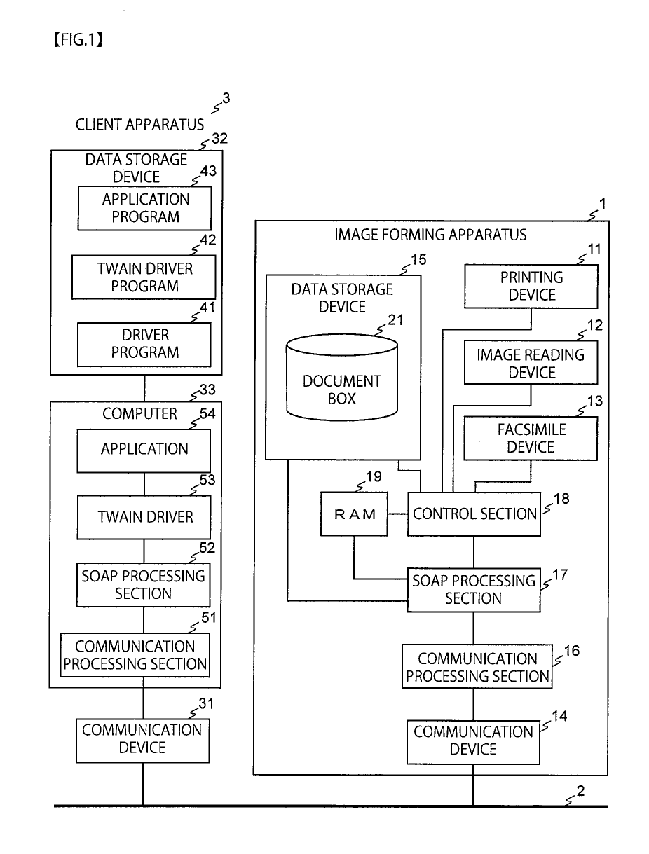

FIG. 1 is a schematic block diagram illustrating the structure of an image forming system according to an embodiment of the present invention. In the image forming system illustrated in FIG. 1, an image forming apparatus 1 is connected to a computer network 2 and a client apparatus 3 is connected to the computer network 2. The image forming apparatus 1 is an apparatus having at least one of the following: a printing function; an image reading function; and a facsimile transmitting/receiving function. The computer network 2 is a network for example, a local area network (LAN) or a wide area network (WAN). The client apparatus 3 is, for example, a personal computer.

The image forming apparatus 1 includes a printing device 11, an image reading device 12, a facsimile device 13, a communication device 14 (an example of a first communication processing section), a data storage device 15, a communication processing section 16, a SOAP processing section 17 (an example of a first message processing section), a control section 18, and a RAM 19.

The printing device 11 is an internal device that can print a document image based on document data. The image reading device 12 is an internal device for optically reading a document image from a document and generating image data of the document image as document data. The facsimile device 13 is an internal device for generating a facsimile signal from document data to be transmitted, transmitting the facsimile signal, and receiving a facsimile signal and converting the facsimile signal into document data.

The communication device 14 is connected to the computer network 2, and can perform data communications with another apparatus (here, the client apparatus 3) connected to the computer network 2. An example of the communication device 14 is a network interface card (NIC).

The data storage device 15 is a device for storing the document data and the like. The data storage device 15 can be a hard disk drive, a nonvolatile memory, or the like. In this embodiment, the data storage device 15 is provided with one or more document boxes 21. Document data is put into the document box 21 and saved therein. The document box 21 is provided for each user or department. The user or a user belonging to the department accesses the document box 21 (including access to document data within the document box 21). The document data includes image data generated from image reading performed by the image reading device 12, image data generated from the facsimile signal received by the facsimile device 13, image data for the backup of an image printed by the printing device 11, and image data for the backup of an image transmitted by the facsimile device 13. Further, the document data may be text data converted from the image data by an optical character reader (OCR). The format of the document data is not limited and may be binary data or text data.

The communication processing section 16 controls the communication device 14 so that it performs data communications through the computer network 2 via Transmission Control Protocol/Internet Protocol (TCP/IP). The communication processing section 16 has a client-server function via Hypertext Transfer Protocol (HTTP).

The SOAP processing section 17 controls the communication processing section 16 so that it transmits/receives a Simple Object Access Protocol (SOAP) message. When the communication processing section 16 receives a document data request message from the client apparatus 3, the SOAP processing section 17 determines whether (a) a request message for causing the image reading apparatus 12 to read a document image and to generate document data and requesting transmission of the document data or (b) a request message for requesting transmission of the document data within the document box 21, is represented by the document data request message. Then, the SOAP processing section generates a response message containing the document data corresponding to the document data request message and causes the communication processing section 16 to transmit the response message to the client apparatus 3.

In this embodiment, the document data request message and the response message are SOAP messages. Further, in this embodiment, the HTTP is bound as a lower-layer protocol than the SOAP, and the image forming apparatus 1 and the client apparatus 3 each have a URL of an endpoint set in advance; each transmits a SOAP message by a POST command via HTTP to the endpoint of the communication counterpart. Therefore, the document data request message and the response message are described according to SOAP, and transmitted/received via HTTP.

The control section 18 is a processing section for controlling the internal device, such as the printing device 11, the image reading device 12, or the facsimile device 13 to execute a job requested by the client apparatus 3 or through an operation panel (not illustrated). The control section 18 stores document data generated in each kind of job in the document box 21 of the data storage device 15, or buffers the document data in the RAM 19.

It should be noted that the communication processing section 16, the SOAP processing section 17, and the control section 18 are implemented by the execution of a predetermined program by a built-in computer (not illustrated). The RAM 19, which is a rewritable memory, may be included in the built-in computer.

Further, the client apparatus 3 includes a communication device 31, a data storage device 32, and a computer 33.

The communication device 31 is connected to the computer network 2 and capable of communicating with another apparatus (here, the image forming apparatus 1) connected to the computer network 2. The communication device 31 can be, for example, a NIC.

The data storage device 32 stores a driver program 41, a Tool Without An Interesting Name (TWAIN) driver program 42, and an application program 43. The data storage device 32 can be a hard disk drive, a nonvolatile memory, or the like. It should be noted that the driver program 41 may be prestored in a recording medium having portability, such as a CD-ROM, and a drive unit for reading the driver program 41 from the recording medium may be used as the data storage device 32.

The computer 33, which includes a central processing unit (CPU) (not illustrated), a random access memory (RAM) (not illustrated), and a read only memory (ROM) (not illustrated), implements each kind of processing section by loading a program into the RAM and executing the program by the CPU. The driver program 41 is executed by the computer 33 to thereby implement a communication processing section 51 (an example of a second communication processing section) and a SOAP processing section 52 (an example of a second message processing section). The driver program 41 is an example of a computer program. The TWAIN driver program 42 is executed by the computer 33 to thereby implement a TWAIN driver 53. The application program 43 is executed by the computer 33 to thereby implement an application 54.

The communication processing section 51 controls the communication device 31 so that it performs data communication through the computer network 2 via TCP/IP. The communication processing section 51 has a client-server function via HTTP.

The SOAP processing section 52 controls the communication processing section 51 so that it transmits/receives a SOAP message. The SOAP processing section 52 causes the communication processing section 51 to transmit a document data request message to the image forming apparatus 1, and when the communication processing section 51 receives the response message from the image forming apparatus 1, it extracts the document data from the response message. The SOAP processing section 52 generates a document data request message based on a request issued from the TWAIN driver 53, or extracts the document data contained in the response message and supplies the TWAIN driver 53 with the document data in a format conforming to TWAIN.

The TWAIN driver 53 receives the document data and issues a request for acquiring the document data according to the specifications of TWAIN.

The application 54 is a processing section for acquiring document data generated by the image reading apparatus 12 included in the image forming apparatus 1 by using the TWAIN driver 53.

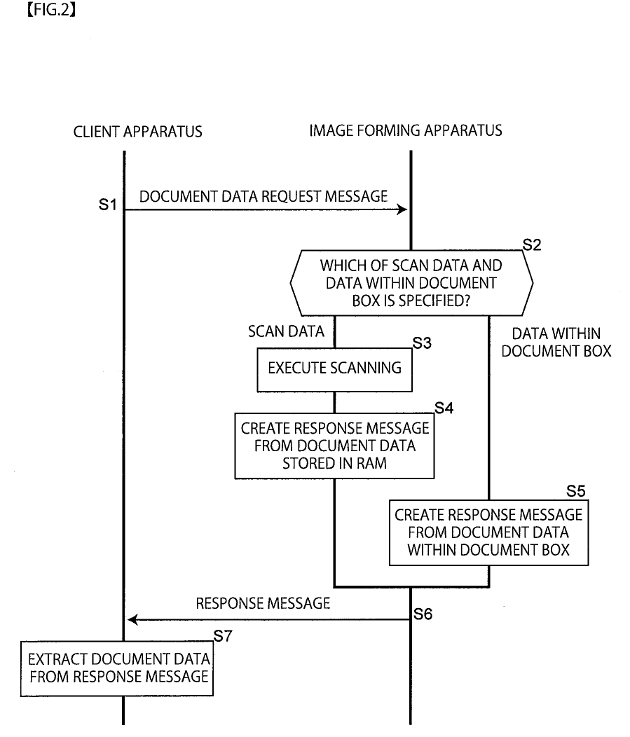

Next, will now be described the operation of components of the image forming system. FIG. 2 is a diagram describing the operation of the components of the image forming system illustrated in FIG. 1.

The application 54 of the client apparatus 3 causes the TWAIN driver 53 to execute acquisition of document data, when either (a) an input operation performed by the user to cause the image reading apparatus 12 of the image forming apparatus 1 to read a document image (hereinafter, referred to as “first user operation”) or (b) an input operation performed by the user to request transmission of the document data stored within the document box 21 after the image reading apparatus 12 reads the document image (hereinafter, referred to as “second user operation”) is detected through an input device (not illustrated) (such as a keyboard).

When the first user operation is detected, the application 54 causes the image reading apparatus 12 to read the document image and generate document data, and causes the TWAIN driver 53 to request the transmission of the document data (hereinafter, referred to as “first document data request”). When the second user operation is detected, the application 54 causes the TWAIN driver 53 to request the transmission of the document data that has been generated by the image reading apparatus 12 reading the document image and which has been stored in the document box 21 (hereinafter, referred to as “second document data request”).

The TWAIN driver 53 issues those requests to the SOAP processing section 52. When one of those requests is issued, the SOAP processing section 52 generates a document data request message, and causes the communication processing section 51 to transmit the document data request message to the image forming apparatus 1 (Step S1). The document data request message is a SOAP message. When the first document data request is issued, the SOAP processing section 52 causes an XML (Extensible Markup Language) element representing the first document data request to be contained in the document data request message. Meanwhile, when the second document data request is issued, the SOAP processing section 52 causes an XML element representing the second document data request to be contained in the document data request message.

Then, the communication processing section 51 of the client apparatus 3 transmits the document data request message to the image forming apparatus 1 by a POST command via HTTP. The document data request message is transmitted through the communication device 31, the computer network 2, and the communication device 14 and received by the communication processing section 16 of the image forming apparatus 1.

The communication processing section 16 of the image forming apparatus 1 supplies the document data request message received via HTTP to the SOAP processing section 17. Upon receipt of the document data request message, the SOAP processing section 17 identifies which of the XML element representing the first document data request and the XML element representing the second document data request is contained in the document data request message (Step S2). It should be noted that when the XML element representing the second document data request is present, information for specifying the document data within the document box 21 to be acquired is contained as a child element of the XML element.

When the XML element representing the first document data request is contained in the document data request message, the SOAP processing section 17 causes the control section 18 to execute the reading of the document image. The control section 18 causes the image reading apparatus 12 to read the document image and to generate document data, and stores the generated document data in the RAM 19 (Step S3). The SOAP processing section 17 generates a response message containing the document data stored in the RAM 19 (Step S4).

Meanwhile, in the situation where the XML element representing the second document data request is contained in the document data request message, the SOAP processing section 17 reads the document data specified in the document data request message from the document box 21, and generates a response message containing the document data (Step S5).

It should be noted that in Steps S4 and S5, the response message is a SOAP message. Further, when the document data includes binary data, the SOAP processing section 17 encodes the document data into text data, and causes the encoded document data to be contained in the response message. In that situation, the document data is encoded in, for example, a BASE64 format.

Thus, after having generated the response message, the SOAP processing section 17 causes the communication processing section 16 to transmit the response message to the client apparatus 3 (Step S6).

On the other hand, on the client apparatus 3, upon receipt of the response message with respect to the document data request message, the communication processing section 51 supplies the response message to the SOAP processing section 52. Upon receipt of the response message containing the document data, the SOAP processing section 52 extracts the document data from the response message, and supplies the response message to the TWAIN driver 53 (Step S7). At this time, when the document data has been encoded into the text data, the SOAP processing section 52 decodes the encoded document data, and supplies the original document data to the TWAIN driver 53. Then, the TWAIN driver 53 supplies the document data to the application 54.

The image forming apparatus 1, according to the above-mentioned embodiment includes: the image reading apparatus 12 for reading the document image and generating the document data; the data storage device 15 having the document box 21 for storing the document data; the communication processing section 16 for receiving the document data request message and transmitting the response message via HTTP; and the SOAP processing section 17 for determining, when the communication processing section 16 receives the document data request message from the client apparatus 3, which of the first document data request and the second document data request is contained in the document data request message, generating the response message containing the document data corresponding to the document data request message, and causing the communication processing section 16 to transmit the response message to the client apparatus 3. The client apparatus 3 includes: the communication processing section 51 for transmitting the document data request message and receiving the response message via HTTP; and the SOAP processing section 52 for causing the communication processing section 51 to transmit the document data request message to the image forming apparatus 1 and extracting the document data from the response message when the communication processing section 51 receives the response message from the image forming apparatus 1.

Accordingly, it is possible by using messages having the same format to access the image reading apparatus 12 and access the document box 21 from the client apparatus 3, which can reduce the burden imposed on the development of a driver used for the client apparatus 3 to acquire the document data generated by the image reading apparatus 12.

Further, in the above-mentioned embodiment, the document data request message and the response message are the SOAP messages.

Accordingly, it is possible to access the image reading apparatus 12 and the document box 21 from the client apparatus 3 by using only the SOAP messages.

Further, in the above-mentioned embodiment, when the document data is not text data, the SOAP processing section 17 encodes the document data into text data by a predetermined encoding format, and causes the encoded document data to be contained in the response message. When the document data is not text data, the SOAP processing section 52 decodes the extracted document data into the original document data by the predetermined encoding format.

Accordingly, when the document data includes binary data, it is possible to transmit/receive the document data via a request message protocol and a response message protocol.

The present invention includes various other embodiments. For example, other designs can be used in which the above-described components and steps are each performed.

For example, the above-mentioned embodiment may be designed so that, when encoding document data into text data by a predetermined encoding format, the SOAP processing section 17 of the image forming apparatus 1 causes information indicating the predetermined encoding format to be contained in the response message as, for example, an XML element. In this situation, the SOAP processing section 52 of the client apparatus 3 extracts the information from the response message, and decodes the document data by a decoding format corresponding to the encoding format specified in the information.

Further, the above-mentioned embodiment may be designed so that the document data is encrypted and then contained in the response message and the response message is transmitted from the image forming apparatus 1 to the client apparatus 3. In that situation, on the client apparatus 3, the document data is extracted from the response message and then decrypted. In that situation, an encryption format used for the encrypted communication may be specified in the document data request message.

Further, the above-mentioned embodiment may be designed so that, when the application 54 issues a request for a preview image, the SOAP processing section 52 detects the request through the TWAIN driver 53, and adds an XML element, representing the request for a preview image, to the document data request message. In that situation, when the SOAP processing section 17 of the image forming apparatus 1 detects the XML element representing the request for a preview image from the document data request message, the SOAP processing section 17 generates a response message containing the document data on the preview image. In the situation of the first document data request, the SOAP processing section 17 causes the control section 18 to read the preview image. The control section 18 controls the image reading apparatus 12 to generate image data on the preview image, and stores the image data in the RAM 19. The SOAP processing section 17 reads the image data on the preview image from the RAM 19 to generate the response message. In the situation of the second document data request, the SOAP processing section 17 reads the preview image data associated with the document data within the document box 21 to generate the response message or generates the preview image data from the document data within the document box 21 to generate the response message.

The present invention can be applied to, for example, a network system including a personal computer and a multifunction peripheral.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An image forming system, comprising:
an image forming apparatus connected to a computer network; and
a client apparatus connected to the computer network,
the image forming apparatus comprising:
an image reading apparatus that reads a document image and generates document data;
a data storage device that stores the document data;
a first communication processing section that receives a document data request message and transmits a response message via one predetermined communication protocol; and
a first message processing section that determines, when the first communication processing section receives the document data request message from the client apparatus, whether a request message for causing the image reading apparatus to read the document image and to generate the document data and requesting transmission of the document data or a request message for requesting transmission of the document data within the data storage device is represented by the document data request message, generates the response message containing the document data corresponding to the document data request message, and causes the first communication processing section to transmit the response message to the client apparatus,
the client apparatus comprising:
a second communication processing section that transmits the document data request message and receives the response message via the predetermined communication protocol; and
a second message processing section that causes the second communication processing section to transmit the document data request message to the image forming apparatus, and extracts, when the second communication processing section receives the response message from the image forming apparatus, the document data from the response message.

2. The image forming system according to claim 1, wherein the document data request message and the response message each comprises a Simple Object Access Protocol (SOAP) message.

3. The image forming system according to claim 1, wherein the predetermined communication protocol comprises Hypertext Transfer Protocol (HTTP).

4. The image forming system according to claim 1, wherein the document data request message and the response message are each transmitted by a POST command via HTTP.

5. The image forming system according to claim 1, wherein the data storage device includes at least one of the document boxes.

6. The image forming system according to claim 5, wherein the document data request message contains information for specifying the document data within the document boxes to be transmitted, when the document data request message is the request message for requesting for the transmission of the document data within the data storage device.

7. The image forming system according to claim 1, wherein:
when the document data is not text data, the first message processing section encodes the document data into text data by a predetermined encoding format, and causes the encoded document data to be contained in the response message; and
when the document data is not text data, the second message processing section decodes the extracted document data into original document data by the predetermined encoding format.

8. The image forming system according to claim 7, wherein the response message contains information specifying the predetermined encoding format.

9. The image forming system according to claim 7, wherein the predetermined encoding format includes a BASE64 format.

10. The image forming system according to claim 1, wherein the document data contained in the response message is encrypted.

11. The image forming system according to claim 10, wherein the document data is decrypted after the document data is extracted from the response message.

12. The image forming system according to claim 1, wherein the second message processing section generates the document data request message based on a request issued from a Tool Without An Interesting Name (TWAIN) driver.

13. The image forming system according to claim 12, wherein the second message processing section extracts the document data, and supplies the TWAIN driver with the document data in a format conforming to TWAIN.

14. An image forming apparatus, which is capable of communicating with a client apparatus through a computer network, comprising:
an image reading apparatus that reads a document image and generates document data;
a data storage device that stores the document data;
a communication processing section that receives a document data request message and transmits a response message via one predetermined communication protocol; and
a message processing section that determines, when the communication processing section receives the document data request message from the client apparatus, whether a request message for causing the image reading apparatus to read the document image and to generate the document data and requesting transmission of the document data or a request message for requesting transmission of the document data within the data storage device is represented by the document data request message, generates the response message containing the document data specified by the document data request message, and causes the communication processing section to transmit the response message to the client apparatus.

15. The image forming apparatus according to claim 14, wherein the document data request message and the response message each include a SOAP message.

16. The image forming apparatus according to claim 14, wherein the predetermined communication protocol includes HTTP.

17. The image forming apparatus according to claim 14, wherein the document data request message and the response message are each transmitted by a POST command via HTTP.

18. The image forming apparatus according to claim 14, wherein the data storage device includes one of the document boxes.

19. A method of operating an image forming system, comprising:
providing an image forming apparatus connected to a computer network having a client apparatus connected thereto;
the image reading apparatus reading a document image and generating document data;
storing document data in a data storage device of the image reading device;
receiving a document data request message and transmitting a response message via one predetermined communication protocol using a first communication processing section of the image reading device;
a first message processing section of the image reading device determining whether a request message for causing the image reading apparatus to read the document image and to generate the document data and requesting transmission of the document data or a request message for requesting transmission of the document data within the data storage device is represented by the document data request message, generating the response message containing the document data corresponding to the document data request message, and causing the first communication processing section to transmit the response message to the client apparatus;
transmitting the document data request message and receiving the response message via the predetermined communication protocol using a second communication processing section of the client apparatus; and
causing the second communication processing section to transmit the document data request message to the image forming apparatus, and extracting, when the second communication processing section receives the response message from the image forming apparatus, the document data from the response message.
